(19) United States
(12) Patent Application Publication
(10) Pub. No.: US 2006/0282329 A1
(43) Pub. Date: Dec. 14, 2006

(54) Method and kit for simulating a restaurant

(76) Inventor: Jane E. Lund, Wahpeton, ND (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/126,582

(22) Filed: May 11, 2005

(51) Int. Cl. G06Q 30/00

(52) U.S. Cl. 705/15

(57) ABSTRACT

The present invention relates to a method and kit for simulating a restaurant. The method and kit include at least one menu, at least one food or beverage item, and simulated currency.

### FIELD OF THE INVENTION

The present invention relates to a method and kit for simulating a restaurant.

### BACKGROUND

Children enjoy role-playing in various simulated or imaginary scenarios. Typical products available to children include simulated non-operational or operational cooking equipment or eating utensils for scenarios relating to home cooking. One disadvantage is that such products do not provide for playing roles relating to operating or visiting an imaginary restaurant.

There is a need in the art for a method and kit for simulating a restaurant.

### BRIEF SUMMARY OF THE INVENTION

In one embodiment, the present invention is a kit for simulating a restaurant comprising at least one menu having a listing of food or beverage selections, at least one food or beverage item, the food or beverage item corresponding with at least one of the food or beverage selections, and simulated currency for paying for ordered food or beverage items.

The present invention, in accordance with another embodiment, is a method for simulating a restaurant including providing a kit for simulating a restaurant, ordering a food or beverage item from the at least one menu, receiving the at least one food or beverage item, and paying for the at least one food item with the simulated currency.

The present invention, in yet another embodiment, is a game for simulating a restaurant comprising at least one menu having a listing of food or beverage selections and a simulated price associated with each of the food or beverage selections, at least one simulated food or beverage item, the food or beverage item corresponding with at least one of the food or beverage selections, and simulated currency.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1A is a front view of a single page menu.

FIG. 1B is a perspective view of a multiple page menu.

FIG. 2 is a front view of a menu shaped to correspond with the theme of the restaurant.

FIG. 3 is a perspective view of a menu showing a listing of several food or beverage selections.

FIG. 4 is a perspective view of several simulated food items.

FIG. 5 is a perspective view of simulated currency.

FIG. 6 is a front and back view of a simulated restaurant OPEN/CLOSE sign and a front view of an apron.

FIG. 7 is a block diagram depicting a method of simulating a restaurant according to one embodiment of the present invention.

### DETAILED DESCRIPTION

The present invention is a method and kit for simulating a restaurant having at least one menu, at least one food or beverage item and simulated currency. The invention allows the users, specifically children, to simulate operation of a restaurant by ordering a food or beverage item from a menu, receiving the ordered food or beverage item and paying for the ordered food or beverage item with the simulated currency.

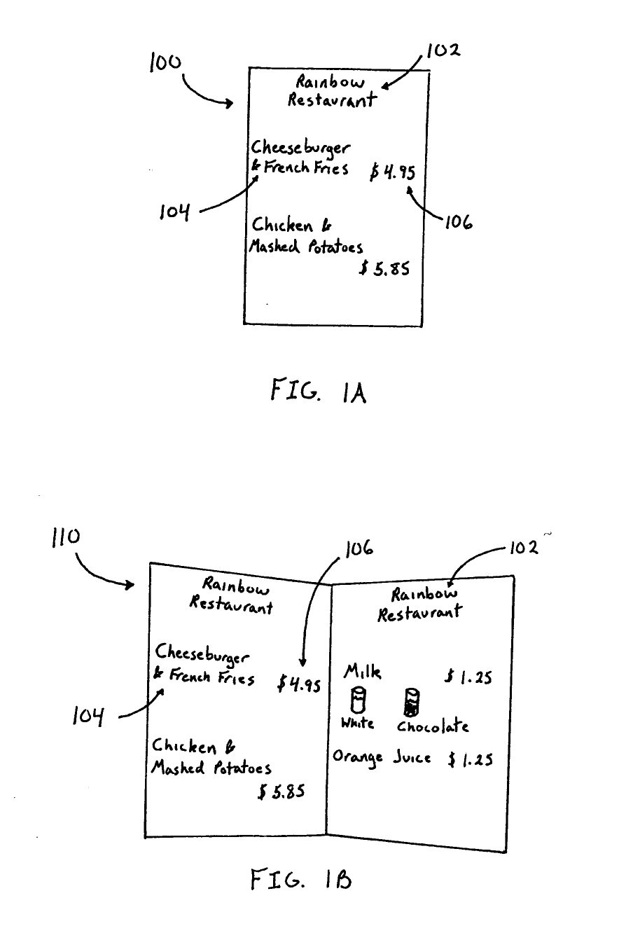

FIG. 1A shows one embodiment of a menu 100 of the present invention. The menu 100 contains the elements of a menu on a single page. Such elements can include the name of the restaurant 102, a description of a variety of food or beverage selections 104 and a price corresponding with each food or beverage selection 106. Note that any name of a restaurant, descriptions of food or beverages, pictures of food or beverages, or prices shown in any of the figures are exemplary and do not limit the invention in any way. The menu can include any known components found on any menu known in the art. FIG. 11B depicts, a multiple page menu 110, according to an alternative embodiment, that operates in similar fashion to a book. The menu 110 provides space for more food or beverage descriptions and pictures of the same.

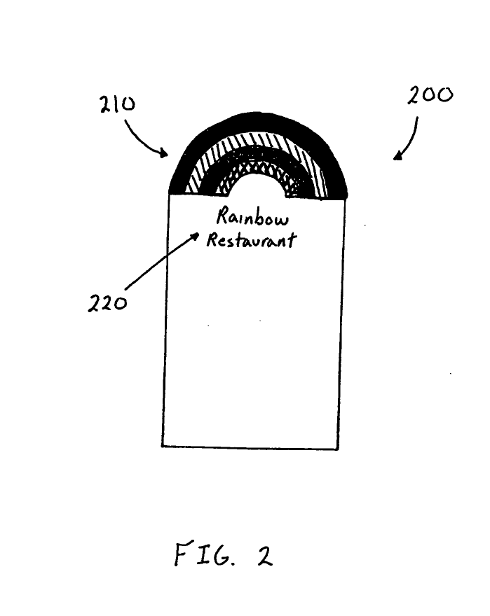

The menu 200 illustrated in FIG. 2, in accordance with a further alternative embodiment, includes a theme of the restaurant. Menu 200 has a rainbow shape 210 on the top edge of the menu 200. The rainbow shape 210 corresponds with “Rainbow Restaurant,” the name of the restaurant 220 given as an example. Alternatively, the menu 200 can include any graphics, drawings, pictures or other decorative theme-based illustrations or designs.

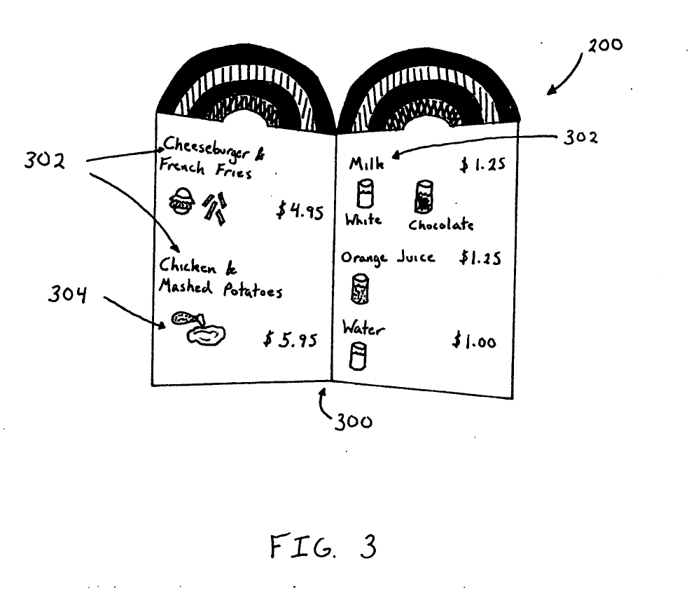

FIG. 3 shows a sample page 300 of a menu according to one embodiment. On the sample page 300, there are several descriptions of food or beverage selections 302. Each food or beverage description 302 has a corresponding picture 304 of that food or beverage and a corresponding price 306 associate with that food or beverage. In one embodiment of the present invention, the food or beverage selections 302 may be separated into one or more indicative categories, such as breakfast, lunch, dinner, appetizers or other known categories.

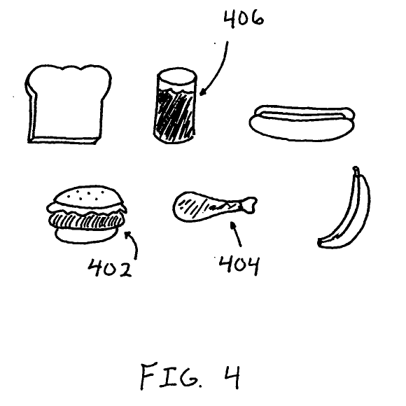

FIG. 4 shows examples of food that may be provided with the present invention. The food items may either be edible or simulated. In one aspect of the present invention, the food or beverage items provided with the present invention correspond with the food or beverage selections 302 listed on the menu 200. For example, simulated food or beverage items 402, 404 and 406 correspond with the food or beverage selections 302 from FIG. 3. FIG. 4 depicts an exemplary set of simulated food or beverage items that may be provided with the present invention and does not limit the invention to the food or beverage items shown. Any known food or beverage item may be used in conjunction with the present invention.

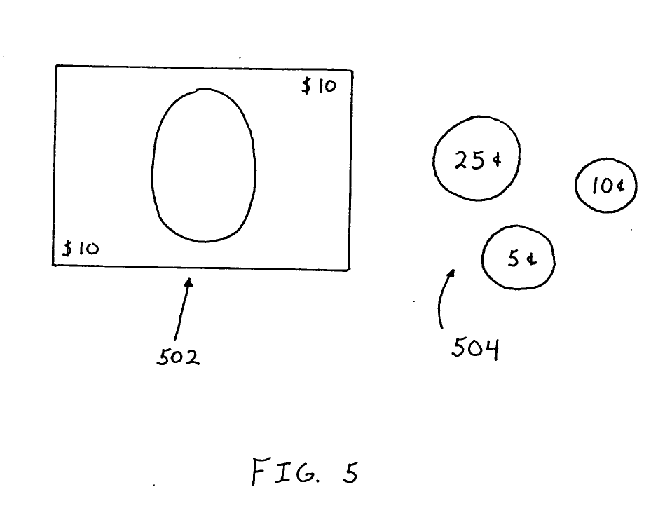

Simulated currency is provided in one embodiment of the present invention. As shown in FIG. 5, the currency can consist of paper currency 502 or coin currency 504 as needed. The simulated currency may simulate any actual currency existing in any part of the world. Alternatively, the simulated currency may consist of make-believe denominations.

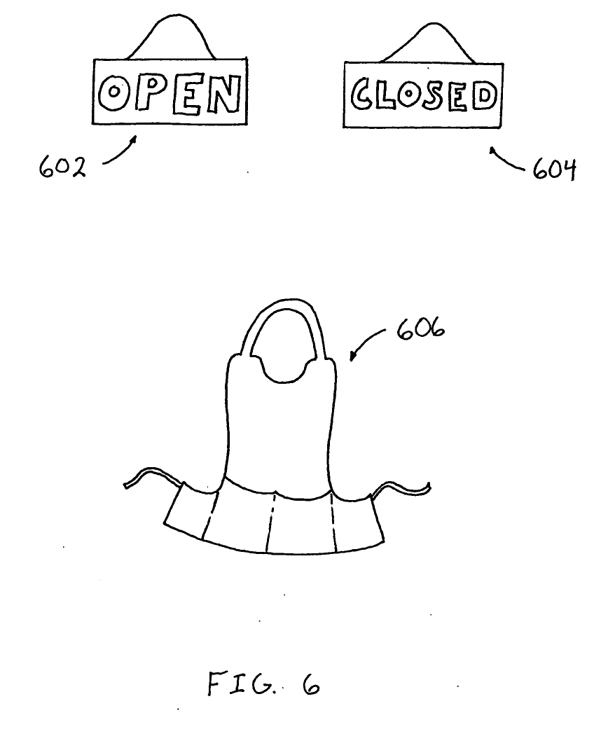

For further effect, one embodiment of the present invention may provide other simulated items similar to those genuine items typically found in an actual restaurant. A sign indicative of whether the simulated restaurant is open or closed for business is an example of such an item. FIG. 6 shows a sign comprising the word “OPEN” on a first side 602 and the word “CLOSED” on a second side 604. The words “OPEN” and “CLOSED” are used merely for illustrative purposes and further language or diverse languages can be used. In one alternative aspect, for example, the sign includes the language “BACK IN 5 MINUTES.” FIG. 6 further illustrates an apron 606 that may be provided with the present invention to simulate those typically worn by servers in a restaurant.

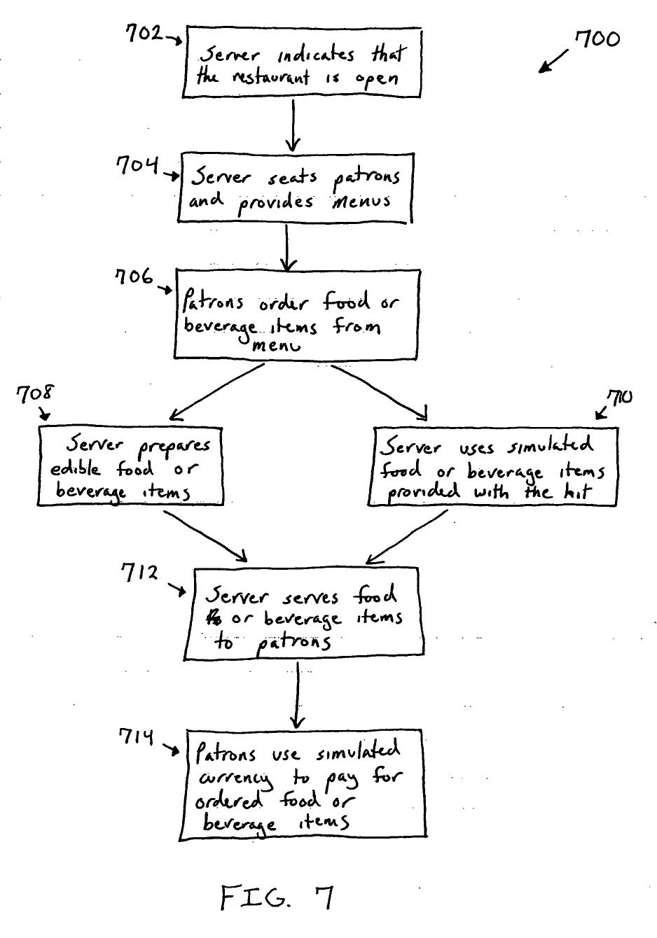

In operation, the present embodiment of the invention can be used by two or more users to simulate a restaurant experience, as illustrated in the block diagram 700 of FIG. 7. In one embodiment, the present invention may be used in the style of a game. One user will simulate a server in a restaurant. Any number of other users will simulate restaurant patrons. At the outset, the server may use a sign that is indicative of whether the simulated restaurant is open to indicate that the simulated restaurant is open to patrons (block 702). The server may then seat the patrons and provide them with menus 300 (block 704). The patrons can order one or more of the food or beverage items shown in the food or beverage selections 302 listed on the menu 300 (block 706). The server may then prepare edible food or beverage items corresponding with the selections made by the patrons (block 708). Alternatively, the server may use simulated food or beverage items provided with the present invention that correspond with the selections made by the patrons (block 710). The server will serve the prepared or simulated food or beverage items to the patrons (block 712). Nearing the conclusion of the simulated restaurant experience, the patrons will then use the simulated currency provided with the present invention to pay for the food or beverage items that were ordered (block 714).

Although the present invention has been described with reference to preferred embodiments, persons skilled in the art will recognize that changes may be made in form and detail without departing from the spirit and scope of the invention.

We claim:

1. A kit for simulating a restaurant comprising:
(a) at least one menu comprising a listing of a plurality of food or beverage selections;
(b) at least one food or beverage item corresponding to the plurality of food or beverage selections; and
(c) simulated currency configured to be used to pay for an ordered food or beverage item.

2. The kit of claim 1 wherein the kit is a game.

3. The kit of claim 1 wherein the at least one menu is laminated.

4. The kit of claim 1 wherein the design scheme of the at least one menu corresponds with the theme of the restaurant.

5. The kit of claim 1 wherein the at least one menu further comprises a simulated price associated with each of the plurality of food or beverage selections.

6. The kit of claim 5 wherein the at least one menu further comprises a picture of a food or beverage item corresponding with each of the plurality of food or beverage selections.

7. The kit of claim 5 wherein the plurality of food or beverage selections comprises foods or beverages of diverse ethnicities.

8. The kit of claim 5 wherein the plurality of food or beverage selections comprises healthy foods or beverages.

9. The kit of claim 1 wherein the at least one food or beverage item comprises an edible food or beverage.

10. The kit of claim 1 wherein the at least one food or beverage item comprises a simulated food or beverage.

11. The kit of claim 1 wherein the simulated currency comprises at least one simulated coin.

12. The kit of claim 1 wherein the simulated currency comprises at least one bill of simulated paper currency.

13. The kit of claim 1 further comprising a sign configured to indicate whether the restaurant is open or closed.

14. The kit of claim 13 wherein the sign comprises:
(a) a first side comprising the word “open;” and
(b) a second side comprising the word “closed.”

15. The kit of claim 1 further comprising an apron.

16. A method for simulating a restaurant comprising:
(a) providing a kit comprising:
(i) at least one simulated menu comprising a listing of a plurality of food or beverage selections;
(ii) at least one food or beverage item corresponding to the plurality of food or beverage selections; and
(iii) simulated currency configured to be used to pay for an ordered food or beverage item;
(b) ordering at least one food or beverage item from the at least one menu;
(c) receiving the at least one food or beverage item; and
(d) paying for the at least one food or beverage item with the simulated currency.
